(19) United States
(12) Patent Application Publication
(10) Pub. No.: US 2025/0314578 A1
(43) Pub. Date: Oct. 9, 2025

(54) NATURAL ENVIRONMENT ACCELERATED CORROSION TEST DEVICE AND METHOD FOR AIR CONDITIONERS

(71) Applicant: CHINA NATIONAL ELECTRIC APPARATUS RESEARCH INSTITUTE CO., LTD., Guangdong (CN)

(72) Inventors: Jun WANG, Guangdong (CN); Shouhe WANG, Guangdong (CN); Miaoran LIU, Guangdong (CN); Li QI, Guangdong (CN); Yang WANG, Guangdong (CN); Huang PENG, Guangdong (CN); Jiaxiang QIN, Guangdong (CN)

(73) Assignee: CHINA NATIONAL ELECTRIC APPARATUS RESEARCH INSTITUTE CO., LTD., Guangdong (CN)

(21) Appl. No.: 19/243,615

(22) Filed: Jun. 19, 2025

Related U.S. Application Data
(63) Continuation of application No. PCT/CN2023/107015, filed on Jul. 12, 2023.

(30) Foreign Application Priority Data
Dec. 27, 2022 (CN) 202211713180.9

(51) Int. Cl. G01N 17/00

(52) U.S. Cl. CPC G01N 17/00

(57) ABSTRACT

The disclosure are a natural environment accelerated corrosion test device and method for air conditioners. The natural environment accelerated corrosion test device for air conditioners, characterized by comprising a base, a rotating power unit, a rotating frame, an air flow acceleration module, a sample surface temperature rise module, a fluid atomization spray module, a service environment monitoring module, and a control system. The disclosure can accelerate the corrosion of the outdoor unit of the tested air conditioner without affecting the normal installation and operation of the outdoor unit in the tested natural environment, and without hindering the influence of the environmental conditions of the tested natural environment on the outdoor unit.

### CROSS-REFERENCE TO RELATED APPLICATION

This application is a continuation of international application of PCT application serial no. PCT/CN2023/107015 filed on Jul. 12, 2023, which claims the priority benefit of China application no. 202211713180.9, filed on Dec. 27, 2022. The entirety of each of the above mentioned patent applications is hereby incorporated by reference herein and made a part of this specification.

### BACKGROUND

### Technical Field

This disclosure relates to an accelerated corrosion test device and method for air conditioners, specifically a natural environment accelerated corrosion test device and method for air conditioners.

### Description of Related Art

Air conditioner, as an important environmental regulation and control device, not only serves ordinary households, but also provides a suitable storage and service environment for weapons and electrical and electronic devices etc. Therefore, the stability and safety of air conditioners during use are crucial. The outdoor unit of air conditioner is generally installed in outdoor atmospheric environment, especially under harsh natural conditions, such as high temperature, high humidity, and high salt in the South China Sea which make the environment highly corrosive. The above situation accelerates the process of corrosion, aging, and failure of different components of the air conditioner, resulting in slower cooling or heating speed of the air conditioner, inability to reach the user set temperature in the room, increased power consumption of the air conditioner, poor user experience, and energy waste.

Based on the above reasons, it is crucial to test and evaluate the service life of air conditioning products in typical climatic environments. At present, there are two main methods for evaluating the environmental adaptability of air conditioning products both domestically and internationally, which are indoor test and outdoor test. The indoor artificial acceleration test can shorten the testing cycle, but cannot fully simulate complex actual environments, resulting in a low correlation between the test and actual service. On the contrary, although the outdoor test can obtain real and reliable data results, its testing cycle is too long and lags far behind product development and improvement. Therefore, ensuring the accuracy and reliability of the environmental adaptability evaluation test results of air conditioners while shortening the test cycle has become an urgent problem to be solved in this technical field.

### SUMMARY

The first technical problem to be solved by the disclosure is to provide natural environment accelerated corrosion test device for air conditioners, thereby solving the problem in the prior art that it is difficult to shorten the test cycle of accelerated corrosion test while balancing the high correlation between the results of accelerated corrosion test and the actual service environment.

The technical solution adopted by the disclosure to solve the above technical problems is as follows.

A natural environment accelerated corrosion test device for air conditioners, characterized by comprising a base, a rotating power unit, a rotating frame, an air flow acceleration module, a sample surface temperature rise module, a fluid atomization spray module, a service environment monitoring module, and a control system.

The top surface of the base is used to place and fix the outdoor unit of the tested air conditioner.

The rotating power unit is capable of driving the rotating frame to rotate back and forth around the central axis of the top surface of the base within a rotation angle range of 0° to 180°. The back of the outdoor unit fixed on the base faces in a direction that is not covered by the rotation angle range, and the left, front, and right sides of the outdoor unit are located at 0°, 90°, and 180° positions of the rotation angle range respectively. The front and back of the outdoor unit are respectively the sides where the cooling fan and condenser pipe of the outdoor unit are located.

The air flow acceleration module, the sample surface temperature rise module, and the fluid atomization spray module are installed on the rotating frame and face above the base. The air flow acceleration module can blow air towards the location of the outdoor unit, effectively accelerating the air flow on the surface of the outdoor unit of the tested air conditioner, thereby increasing the deposition rate of corrosive media on its surface, to achieve corrosion acceleration. The sample surface temperature rise module can heat the location of the outdoor unit, increasing the surface temperature of the outdoor unit of the tested air conditioner, thereby increasing the corrosion rate on the surface of metal components. The fluid atomization spray module can spray atomized pure water and salt solution separately to the location of the outdoor unit, increasing the environmental humidity and concentration of corrosive media in the air of the tested natural environment where the outdoor unit is located respectively, to achieve corrosion acceleration.

The service environment monitoring module is capable of real-time monitoring of the service environment parameters of the tested natural environment in which the outdoor unit is located. The service environment parameters are used to calculate the accelerated corrosion test results of the tested air conditioner operating in the tested natural environment.

The control system is electrically connected to the control end of the rotating power unit, the control end of the air flow acceleration module, the control end of the sample surface temperature rise module, the control end of the fluid atomization spray module, and the output end of the service environment monitoring module.

Preferably, the rotating power unit is installed inside the base. The side of the base is provided with a connecting slot, and the top surface of the base is provided with several cable through holes.

The rotating frame is an L-shaped structure composed of a horizontal connecting rod and a vertical frame. The horizontal connecting rod extends into the interior of the base through the connecting slot, connected to the rotating shaft of the rotating power unit. The vertical frame is located outside the base, and the air flow acceleration module, the sample surface temperature rise module, and the fluid atomization spray module are all installed on the vertical frame.

The sensor host of the service environment monitoring module is placed inside the base, and the sensor probes of the service environment monitoring module are arranged above the base. The cables between the sensor host and the sensor probes passe through the cable through holes.

Thus, the base, the rotating power unit, the rotating frame, the service environment monitoring module, the air flow acceleration module, the sample surface temperature rise module, and the fluid atomization spray module are integrated into one, which can facilitate the transportation and use of the natural environment accelerated corrosion test device for air conditioners between different tested natural environments.

The rotating power unit preferably drives the horizontal connecting rod of the rotating frame to rotate through a servo motor and a worm gear mechanism. And by controlling the forward and reverse rotation of the motor shaft of the servo motor, the rotating frame is driven to rotate back and forth around the central axis of the top surface of the base within a rotation angle range of at least 180° but less than 360°, so that the rotating frame and the modules installed on it can accurately stay in different directions of the outdoor unit.

Preferably, the air flow acceleration module comprises a fan array composed of multiple fans, for example, as shown in FIG. 1, the fan array consisting of 35 fans in 7 rows*5 columns, with an effective air receiving area sufficient to cover the outdoor units of the air conditioners of horsepower or less. Each fan's air outlet is equipped with a grille for adjusting the direction of air flow to ensure that the effective air receiving area of the fan array covers the outdoor unit of the air conditioner. Each fan can be independently switched on and off and adjusted airflow velocity, with a preferred airflow velocity adjustment range from 0 to 8 m/s, to adapt to different sizes of outdoor units and different airflow velocity requirements. Therefore, during the test, the number of fans turned on and the direction of air outlet can be adjusted according to the height of the outdoor unit, in order to minimize the number of fans turned on as much as possible while the outdoor unit is within the effective air receiving area of the air flow acceleration module, to reduce energy consumption.

Preferably, the sample surface temperature rise module comprises multiple sets of infrared lamps distributed on both sides of the air flow acceleration module, which are installed in lamp slots with waterproof protection. The lamp slots can adjust the direction of the emitted light of the infrared lamps, and each set of infrared lamps can be independently switched on and off, to adapt to different sizes outdoor units and different temperature rise area requirements. Therefore, during the test, the number of infrared lamps turned on and the direction of the emitted light can be adjusted according to the height of the outdoor unit, in order to minimize the number of infrared lamps turned on as much as possible while uniformly heating the outer surface of the outdoor unit, to reduce energy consumption.

Preferably, the fluid atomization spray module comprises a dual chamber water tank, an air compressor, and multiple ultrasonic nozzles. The two chambers of the dual chamber water tank store pure water and salt solution respectively. The ultrasonic nozzles are divided into two groups and arranged on the left and right sides of the air flow acceleration module. The air compressor is capable of extracting pure water or salt solution from the dual chamber water tank and spraying it through the ultrasonic nozzles in an atomized manner after being pressurized by the air compressor. In addition, the salt solution can also be added corresponding amounts of corrosive pollutants, such as sulfur ions, chloride ions, etc., based on the content of corrosive pollutants in the natural environment where the outdoor unit of the air conditioner is tested.

Preferably, the service environment monitoring module and its monitored service environment parameters include:
multiple temperature sensors, which are used to monitor the internal temperature, the external air temperature, and the surface temperature of the outdoor unit respectively, wherein the external air temperature is the air temperature of the tested natural environment in which the outdoor unit is located,
multiple humidity sensors, which are used to monitor the internal and external humidity of the outdoor unit respectively, wherein the external humidity is the humidity of the tested natural environment in which the outdoor unit is located,
multiple airflow velocity sensors, which are used to monitor the internal and external airflow velocities of the outdoor unit respectively, wherein the external airflow velocity is the airflow velocity of the tested natural environment in which the outdoor unit is located,
multiple laser-based salt mist sensors, which are used to monitor the internal and external salt mist concentration of the outdoor unit respectively, wherein the external salt mist concentration is the salt mist concentration in the tested natural environment in which the outdoor unit is located,
multiple corrosion sensors, which are used to monitor the internal and external metal corrosion rates of the outdoor unit respectively, wherein the external metal corrosion rate is the metal corrosion rate of the tested natural environment in which the outdoor unit is located.

The second technical problem to be solved by the disclosure is to provide a natural environment accelerated corrosion test method for air conditioners, thereby solving the problem in the prior art that it is difficult to shorten the test cycle of accelerated corrosion test while balancing the high correlation between the results of accelerated corrosion test and actual service environment.

The technical solution adopted by the disclosure to solve the above technical problems is as follows.

A natural environment accelerated corrosion test method for air conditioners, characterized in that it is implemented based on the natural environment accelerated corrosion test device for air conditioners, and includes:
step S1: install the tested air conditioner in its normal operating state, wherein the indoor unit of the tested air conditioner is installed indoors, and the outdoor unit of the tested air conditioner is in the tested natural environment and fixed on the top surface of the base;
step S2: power on the tested air conditioner, and set its operating time, operating mode, operating temperature, and operating air speed to the common time period, cooling mode, minimum operating temperature, and maximum operating air speed, respectively; wherein, the common time period is set according to the actual operating scenario of the tested air conditioner, for example, if the tested air conditioner is a household air conditioner, the common time period can be set from 18:00 to 8:00, and if the tested air conditioner is a commercial air conditioner, the common time period can be set from 8:00 to 18:00;
step S3: power on the natural environment accelerated corrosion test device for air conditioners, and adjust the blowing position of the air flow acceleration module and the heating position of the sample surface temperature rise module according to the height of the outdoor unit, so that the outdoor unit as a whole is located within the effective air receiving area of the air flow acceleration module, and the outer surface of the outdoor unit can be uniformly heated, wherein, the temperature deviation of the heated part of the outer surface of the outdoor unit is generally required to be within 2° C.;
step S4: control the natural environment accelerated corrosion test device for air conditioners through the control system to automatically operate in the following manner to achieve accelerated corrosion test of the tested air conditioner:
step S4-1: control the rotating power unit to drive the rotating frame to rotate back and forth within the rotation angle range, and control the rotating frame to stay at the 0° and 180° positions of the rotation angle range according to the preset position change cycle during the operation time of the tested air conditioner, and control the rotating power unit to drive the rotating frame to stay at the 0°, 90°, and 180° positions of the rotation angle range according to the position change cycle during the non-operation time of the tested air conditioner, so as to avoid the rotating frame staying at the 90° position during the tested air conditioner operating, which may block the cooling fan of the outdoor unit and hinder the normal operation of the tested air conditioner;
step S4-2: control the air flow acceleration module to operate continuously throughout the day to continuously increase the air flow in the tested natural environment during the test;
step S4-3: according to the preset method, control the sample surface temperature rise module to intermittently heat the location of the outdoor unit, in order to increase the temperature around the outdoor unit; control the fluid atomization spray module to intermittently spray atomized pure water to the location of the outdoor unit for humidification, to increase the relative humidity and dry-wet alternation frequency around the outdoor unit; control the fluid atomization spray module to intermittently spray atomized salt solution to the location of the outdoor unit, in order to increase the salt mist concentration around the outdoor unit;
step S4-4: during the duration of the accelerated corrosion test, control the service environment monitoring module to monitor in real-time the service environment parameters of the tested natural environment in which the outdoor unit is located, so as to be able to calculate the accelerated corrosion test results of the tested air conditioner operating in the natural environment using the monitored service environment parameters after the accelerated corrosion test is completed; moreover, during the duration of the accelerated corrosion test, the appearance changes, performance and characteristic changes of the tested air conditioner can be regularly observed and recorded, such as energy efficiency changes, power consumption changes, cooling capacity changes, etc., wherein the duration of the accelerated corrosion test is preferably one year.

Thereby, the disclosure can accelerate the corrosion of the outdoor unit of the tested air conditioner without affecting the normal installation and operation of the outdoor unit in the tested natural environment, and without hindering the influence of the environmental conditions of the tested natural environment on the outdoor unit. Therefore, the disclosure can effectively shorten the test cycle of the accelerated corrosion test while ensuring a high correlation between the results of the accelerated corrosion test and the actual service environment of the tested air conditioner which is the tested natural environment.

Wherein:

The disclosure places the outdoor unit of the tested air conditioner in the natural environment and fixes it on the top surface of the base, with the back of the outdoor unit facing the direction that is not covered by the rotation angle range of the rotating frame, so that the rotating frame avoids the condenser pipe between the outdoor unit and the indoor unit of the air conditioner when rotating back and forth within the rotation angle range. During the tested air conditioner operating, the rotating frame is only controlled to stay in the 0° and 180° positions of the rotation angle range, avoiding the rotating frame staying in the 90° position and blocking the cooling fan of the outdoor unit, which hinders the normal operation of the tested air conditioner. Thus, it ensures that the normal installation and operation of the outdoor unit of the tested air conditioner in the tested natural environment are not affected, and the impact of environmental conditions in the tested natural environment on the outdoor unit are not hindered.

During the accelerated corrosion test of the tested air conditioner, the rotating frame stay in the 0°, 90°, and 180° positions within the rotation angle range derived by the rotating power unit, that is to stay in three different positions on the left, front, and right sides of the outdoor unit, so that the air flow acceleration module, the sample surface temperature rise module, and the fluid atomization spray module can apply accelerated corrosion environmental factors to the outdoor unit from different positions. Wherein, by using the air flow acceleration module, the air flow on the surface of the outdoor unit of the tested air conditioner can be accelerated, increasing the deposition rate of corrosive media in the air on its surface; by using the sample surface temperature rise module, the surface temperature of the outdoor unit of the tested air conditioner can be increased, increasing the corrosion rate of the metal component surface; by using the fluid atomization spray module, the environmental humidity or concentration of corrosive media in the air of the tested natural environment where the outdoor unit is located can be increased. Thus, the purpose of accelerating the corrosion of the outdoor unit of the tested air conditioner under natural environmental conditions is achieved.

As a preferred embodiment of the disclosure, the preset method in step S4-3 includes:
step S4-3A: during the daytime of the accelerated corrosion test, when the rotating frame stays in one position within the rotation angle range each time, the fluid atomization spray module is controlled to spray atomized pure water to the location of the outdoor unit within a preset humidification duration, in order to perform humidification treatment and increase the relative humidity and dry-wet alternation frequency around the outdoor unit;

during the dark time of the accelerated corrosion test, when the rotating frame stays at one position within the rotation angle range each time, the fluid atomization spray module is controlled to spray atomized salt solution to location of the outdoor unit within the preset spray duration, and the sample surface temperature rise module is controlled to heat the location of the outdoor unit within the preset heating duration, in order to improve the salt mist concentration and temperature around the outdoor unit.

Wherein, the position change cycle is preferably 1 h, the humidification duration is preferably 10 min, and the spray duration and the heating duration are preferably 5 min.

Therefore, by adopting the method described in step S4-3A, the natural environment accelerated corrosion test method for air conditioners can be applied to the tested natural environment with stable environmental conditions and clear changes in environmental conditions, so as to conduct accelerated corrosion tests on multiple tested air conditioners under the same conditions, making the test more reproducible.

As a preferred embodiment of the disclosure, the preset method in step S4-3 includes:
step S4-3B: when the air temperature of the tested natural environment is lower than the preset air temperature threshold, the sample surface temperature rise module is controlled to heat the location of the outdoor unit within the preset heating time to increase the temperature around the outdoor unit;
when the average relative humidity of the tested natural environment is lower than the preset humidity threshold, the fluid atomization spray module is controlled to spray atomized pure water to the location of the outdoor unit within the preset humidification time for humidification treatment, to increase the relative humidity and dry-wet alternation frequency around the outdoor unit;
when the salt mist concentration of the tested natural environment is lower than the preset salt mist concentration threshold, the fluid atomization spray module is controlled to spray the atomized salt solution to the position of the outdoor unit within the preset spray time, so as to improve the salt mist concentration around the outdoor unit.

Wherein, the air temperature threshold is preferably 20° C.; the humidity threshold is preferably 80%; the salt mist concentration threshold is preferably 0.1 mg/m³; the humidification time is preferably 10 min, and the heating time and the spray time are preferably 5 min.

Therefore, by adopting the method described in step S4-3B, the natural environment accelerated corrosion test method for air conditioners can be applied to the tested natural environment with complex environmental conditions and unclear changes in environmental conditions, in order to conduct accelerated corrosion test on the tested air conditioner in a more resource efficient manner.

Compared with the prior art, the disclosure has the following beneficial effects.
1. the disclosure can accelerate the corrosion of the outdoor unit of the tested air conditioner without affecting its normal installation and operation in the tested natural environment, and without hindering the influence of the environmental conditions of the tested natural environment on the outdoor unit. Therefore, the disclosure can effectively shorten the test cycle of the accelerated corrosion test while ensuring a high correlation between the results of the accelerated corrosion test and the actual service environment of the tested air conditioner which is the tested natural environment.

Wherein:

The disclosure places the outdoor unit of the tested air conditioner in the natural environment and fixes it on the top surface of the base, with the back of the outdoor unit facing the direction that is not covered by the rotation angle range of the rotating frame, so as to avoid the condenser pipe between the outdoor unit and the indoor unit of the air conditioner when the rotating frame rotates back and forth within the rotation angle range. During the tested air conditioner operating, the rotating frame is only controlled to stay in the 0° and 180° positions of the rotation angle range, avoiding the rotating frame staying in the 90° position and blocking the cooling fan of the outdoor unit, which hinders the normal operation of the tested air conditioner. Thus, it ensures that the normal installation and operation of the outdoor unit of the tested air conditioner in the tested natural environment are not affected, and the impact of environmental conditions in the tested natural environment on the outdoor unit are not hindered.

During the accelerated corrosion test of the tested air conditioner, the rotating frame stay in the 0°, 90°, and 180° positions within the rotation angle range derived by the rotating power unit, that is to stay in three different positions on the left, front, and right sides of the outdoor unit, so that the air flow acceleration module, the sample surface temperature rise module, and the fluid atomization spray module can apply accelerated corrosion environmental factors to the outdoor unit from different positions. Wherein, by using the air flow acceleration module, the air flow on the surface of the outdoor unit of the tested air conditioner can be accelerated, increasing the deposition rate of corrosive media in the air on its surface; by using the sample surface temperature rise module, the surface temperature of the outdoor unit of the tested air conditioner can be increased, increasing the corrosion rate of the metal component surface; by using the fluid atomization spray module, the environmental humidity or concentration of corrosive media in the air of the tested natural environment where the outdoor unit is located can be increased. Thus, the purpose of accelerating the corrosion of the outdoor unit of the tested air conditioner under natural environmental conditions is achieved.
2. The disclosure adopts a base and a rotating frame, integrating the base, the rotating power unit, the rotating frame, the service environment monitoring module, the air flow acceleration module, the sample surface temperature rise module, and the fluid atomization spray module, which can facilitate the transportation and use of the natural environment accelerated corrosion test device for air conditioners between different tested natural environments.
3. By adopting the method described in step S4-3A, the natural environment accelerated corrosion test method for air conditioners can be applied to the tested natural environment with stable environmental conditions and clear changes in environmental conditions, so as to conduct accelerated corrosion tests on multiple tested air conditioners under the same conditions, making the test more reproducible.
4. By adopting the method described in step S4-3B, the natural environment accelerated corrosion test method for air conditioners can be applied to the tested natural environment with complex environmental conditions and unclear changes in environmental conditions, in order to conduct accelerated corrosion test on the tested air conditioner in a more resource efficient manner.

### BRIEF DESCRIPTION OF THE DRAWINGS

The disclosure will be further described in detail with reference to the accompanying drawings and specific embodiments.

FIG. 1 is a schematic diagram of the structure of the natural environment accelerated corrosion test device for air conditioners.

FIG. 2 is a schematic diagram of the structure of the base with a perspective effect.

FIG. 3 is a schematic diagram of the usage state of the natural environment accelerated corrosion test device for air conditioners.

### DETAILED DESCRIPTION OF DISCLOSED EMBODIMENTS

The disclosure will be described in detail below with reference to the embodiments and the accompanying drawings, in order to assist those skilled in the art in better understanding the inventive concept of the disclosure. However, the scope of protection of the claims of the disclosure is not limited to the following embodiments. For those skilled in the art, all other embodiments obtained without creative labor without departing from the inventive concept of the disclosure are within the scope of protection of the disclosure.

### Embodiment 1

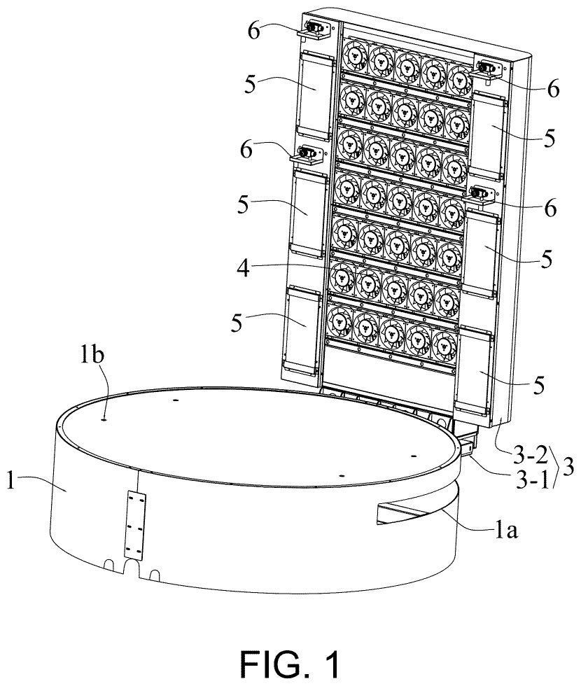

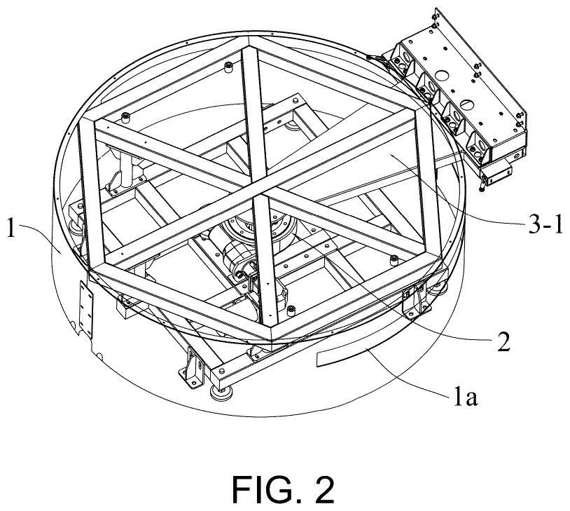

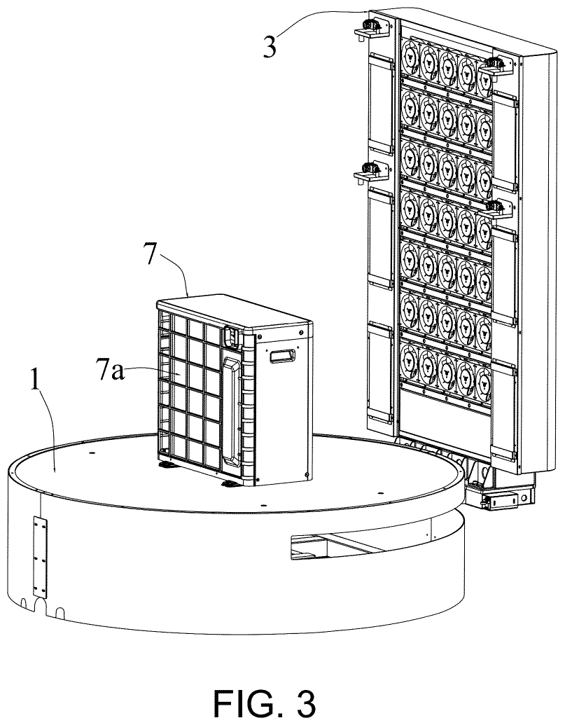

As shown in FIG. 1 to 3, it discloses the natural environment accelerated corrosion test device for air conditioners, comprising the base 1, the rotating power unit 2, the rotating frame 3, the air flow acceleration module 4, the sample surface temperature rise module 5, the fluid atomization spray module 6, the service environment monitoring module (not shown) and the control system (not shown).

The top surface of the base 1 is used to place and fix the outdoor unit 7 of the tested air conditioner.

The rotating power unit 2 is capable of driving the rotating frame 3 to rotate back and forth around the central axis of the top surface of the base 1 within a rotation angle range of 0° to 180°. The back 7a of the outdoor unit 7 fixed on the base faces in a direction not covered by the rotation angle range, and the left, front, and right sides of the outdoor unit 7 are located at 0°, 90°, and 180° positions of the rotation angle range respectively. The front and back 7a of the outdoor unit 7 are respectively the sides where the cooling fan and condenser pipe of the outdoor unit 7 are located.

The air flow acceleration module 4, the sample surface temperature rise module 5, and the fluid atomization spray module 6 are installed on the rotating frame 3 and face above the base 1. The air flow acceleration module 4 can blow air towards the location of the outdoor unit 7, effectively accelerating the air flow on the surface of the outdoor unit 7 of the tested air conditioner, thereby increasing the deposition rate of corrosive media on its surface, to achieve corrosion acceleration. The sample surface temperature rise module 5 can heat the location of the outdoor unit 7, increasing the surface temperature of the outdoor unit 7 of the tested air conditioner, thereby increasing the corrosion rate on the surface of metal components. The fluid atomization spray module 6 can spray atomized pure water and salt solution separately to the location of the outdoor unit 7, increasing the environmental humidity and concentration of corrosive media in the air of the tested natural environment where the outdoor unit 7 is located respectively, to achieve corrosion acceleration.

The service environment monitoring module is capable of real-time monitoring of the service environment parameters of the tested natural environment in which the outdoor unit 7 is located. The service environment parameters are used to calculate the accelerated corrosion test results of the tested air conditioner operating in the tested natural environment.

The control system is electrically connected to the control end of the rotating power unit 2, the control end of the air flow acceleration module 4, the control end of the sample surface temperature rise module 5, the control end of the fluid atomization spray module 6, and the output end of the service environment monitoring module.

It also discloses the natural environment accelerated corrosion test method for air conditioners, which is implemented based on the natural environment accelerated corrosion test device for air conditioners, including:
step S1: install the tested air conditioner in its normal operating state, wherein the indoor unit of the tested air conditioner is installed indoors, and the outdoor unit 7 of the tested air conditioner is in the tested natural environment and fixed on the top surface of the base 1;
step S2: power on the tested air conditioner, and set its operating time, operating mode, operating temperature, and operating air speed to the common time period, cooling mode, minimum operating temperature, and maximum operating air speed, respectively; wherein, the common time period is set according to the actual operating scenario of the tested air conditioner, for example, if the tested air conditioner is a household air conditioner, the common time period can be set from 18:00 to 8:00, and if the tested air conditioner is a commercial air conditioner, the common time period can be set from 8:00 to 18:00;
step S3: power on the natural environment accelerated corrosion test device for air conditioners, and adjust the blowing position of the air flow acceleration module 4 and the heating position of the sample surface temperature rise module 5 according to the height of the outdoor unit 7, so that the outdoor unit 7 as a whole is located within the effective air receiving area of the air flow acceleration module 4, and the outer surface of the outdoor unit 7 can be uniformly heated, wherein, the temperature deviation of the heated part of the outer surface of the outdoor unit 7 is generally required to be within 2° C.;
step S4: control the natural environment accelerated corrosion test device for air conditioners through the control system to automatically operate in the following manner to achieve accelerated corrosion test of the tested air conditioner:
step S4-1: control the rotating power unit 2 to drive the rotating frame 3 to rotate back and forth within the rotation angle range, and control the rotating frame 3 to stay at the 0° and 180° positions of the rotation angle range according to the preset position change cycle during the operation time of the tested air conditioner, and control the rotating power unit 2 to drive the rotating frame 3 to stay at the 0°, 90°, and 180° positions of the rotation angle range according to the position change cycle during the non-operation time of the tested air conditioner, so as to avoid the rotating frame 3 staying at the 90° position during the tested air conditioner operating, which may block the cooling fan of the outdoor unit 7 and hinder the normal operation of the tested air conditioner;
step S4-2: control the air flow acceleration module 4 to operate continuously throughout the day to continuously increase the air flow in the tested natural environment during the test;
step S4-3: according to the preset method, control the sample surface temperature rise module 5 to intermittently heat the location of the outdoor unit 7, in order to increase the temperature around the outdoor unit 7; control the fluid atomization spray module 6 to intermittently spray atomized pure water to the location of the outdoor unit 7 for humidification, to increase the relative humidity and dry-wet alternation frequency around the outdoor unit 7; control the fluid atomization spray module 6 to intermittently spray atomized salt solution to the location of the outdoor unit 7, in order to increase the salt mist concentration around the outdoor unit 7;
step S4-4: during the duration of the accelerated corrosion test, control the service environment monitoring module to monitor in real-time the service environment parameters of the tested natural environment in which the outdoor unit 7 is located, so as to be able to calculate the accelerated corrosion test results of the tested air conditioner operating in the natural environment using the monitored service environment parameters after the accelerated corrosion test is completed; moreover, during the duration of the accelerated corrosion test, the appearance changes, performance and characteristic changes of the tested air conditioner can be regularly observed and recorded, such as energy efficiency changes, power consumption changes, cooling capacity changes, etc., wherein the duration of the accelerated corrosion test is preferably one year.

Thereby, the disclosure can accelerate the corrosion of the outdoor unit 7 of the tested air conditioner without affecting the normal installation and operation of the outdoor unit 7 in the tested natural environment, and without hindering the influence of the environmental conditions of the tested natural environment on the outdoor unit 7. Therefore, the disclosure can effectively shorten the test cycle of the accelerated corrosion test while ensuring a high correlation between the results of the accelerated corrosion test and the actual service environment of the tested air conditioner which is the tested natural environment.

Wherein:

The disclosure places the outdoor unit 7 of the tested air conditioner in the natural environment and fixes it on the top surface of the base 1, with the back 7a of the outdoor unit 7 facing the direction not covered by the rotation angle range of the rotating frame 3, so that the rotating frame 3 avoids the condenser pipe between the outdoor unit 7 and the indoor unit of the air conditioner when rotating back and forth within the rotation angle range. During the tested air conditioner operating, the rotating frame 3 is only controlled to stay in the 0° and 180° positions of the rotation angle range, to avoid the rotating frame 3 staying in the 90° position and blocking the cooling fan of the outdoor unit 7, which hinders the normal operation of the tested air conditioner. Thus, it ensures that the normal installation and operation of the outdoor unit 7 of the tested air conditioner in the tested natural environment are not affected, and the impact of environmental conditions in the tested natural environment on the outdoor unit 7 are not hindered.

During the accelerated corrosion test of the tested air conditioner, the rotating frame 3 stay in the 0°, 90°, and 180° positions within the rotation angle range derived by the rotating power unit 2, that is to stay in three different positions on the left, front, and right sides of the outdoor unit 7, so that the air flow acceleration module 4, the sample surface temperature rise module 5, and the fluid atomization spray module 6 can apply accelerated corrosion environmental factors to the outdoor unit 7 from different positions. Wherein, by using the air flow acceleration module 4, the air flow on the surface of the outdoor unit 7 of the tested air conditioner can be accelerated, increasing the deposition rate of corrosive media in the air on its surface; by using the sample surface temperature rise module 5, the surface temperature of the outdoor unit 7 of the tested air conditioner can be increased, increasing the corrosion rate of the metal component surface; by using the fluid atomization spray module 6, the environmental humidity or concentration of corrosive media in the air of the tested natural environment where the outdoor unit 7 is located can be increased. Thus, the purpose of accelerating the corrosion of the outdoor unit 7 of the tested air conditioner under natural environmental conditions is achieved.

The above is the basic implementation method in Embodiment 1, which can be further optimized, improved, and limited based on this basic implementation method.

Preferably, the rotating power unit 2 is installed inside the base 1. The side of the base 1 is provided with a connecting slot 1a, and the top surface of the base 1 is provided with several cable through holes 1b.

The rotating frame 3 is an L-shaped structure composed of a horizontal connecting rod 3-1 and a vertical frame 3-2. The horizontal connecting rod 3-1 extends into the interior of the base 1 through the connecting slot 1a, connected to the rotating shaft of the rotating power unit 2. The vertical frame 3-2 is located outside the base 1, and the air flow acceleration module 4, the sample surface temperature rise module 5, and the fluid atomization spray module 6 are all installed on the vertical frame 3-2.

The sensor host of the service environment monitoring module is placed inside the base 1, and the sensor probes of the service environment monitoring module are arranged above the base 1. The cables between the sensor host and the sensor probes passe through the cable through holes 1b.

Thus, the base 1, the rotating power unit 2, the rotating frame 3, the service environment monitoring module, the air flow acceleration module 4, the sample surface temperature rise module 5, and the fluid atomization spray module 6 are integrated into one, which can facilitate the transportation and use of the natural environment accelerated corrosion test device for air conditioners between different tested natural environments.

The rotating power unit 2 preferably drives the horizontal connecting rod 3-1 of the rotating frame 3 to rotate through a servo motor and a worm gear mechanism. And by controlling the forward and reverse rotation of the motor shaft of the servo motor, the rotating frame 3 is driven to rotate back and forth around the central axis of the top surface of the base 1 within a rotation angle range of at least 180° but less than 360°, so that the rotating frame 3 and the modules installed on it can accurately stay in different directions of the outdoor unit 7.

Preferably, the air flow acceleration module 4 comprises a fan array composed of multiple fans, for example, as shown in FIG. 1, the fan array consisting of 35 fans in 7 rows*5 columns, with an effective air receiving area sufficient to cover the outdoor units of the air conditioners of 10 horsepower or less. Each fan's air outlet is equipped with a grille for adjusting the direction of air flow to ensure that the effective air receiving area of the fan array covers the outdoor unit 7 of the air conditioner. Each fan can be independently switched on and off and adjusted airflow velocity, with a preferred airflow velocity adjustment range from 0 to 8 m/s, to adapt to different sizes of outdoor units 7 and different airflow velocity requirements. Therefore, during the test, the number of fans turned on and the direction of air outlet can be adjusted according to the height of the outdoor unit 7, in order to minimize the number of fans turned on as much as possible while the outdoor unit 7 is within the effective air receiving area of the air flow acceleration module 4, to reduce energy consumption.

Preferably, the sample surface temperature rise module 5 comprises multiple sets of infrared lamps distributed on both sides of the air flow acceleration module 4, which are installed in lamp slots with waterproof protection. The lamp slots can adjust the direction of the emitted light of the infrared lamps, and each set of infrared lamps can be independently switched on and off, to adapt to different sizes outdoor units 7 and different temperature rise area requirements. Therefore, during the test, the number of infrared lamps turned on and the direction of the emitted light can be adjusted according to the height of the outdoor unit 7, in order to minimize the number of infrared lamps turned on as much as possible while uniformly heating the outer surface of the outdoor unit 7, to reduce energy consumption.

Preferably, the fluid atomization spray module 6 comprises a dual chamber water tank, an air compressor, and multiple ultrasonic nozzles. The two chambers of the dual chamber water tank store pure water and salt solution respectively. The ultrasonic nozzles are divided into two groups and arranged on the left and right sides of the air flow acceleration module 4. The air compressor is capable of extracting pure water or salt solution from the dual chamber water tank and spraying it through the ultrasonic nozzles in an atomized manner after being pressurized by the air compressor. In addition, the salt solution can also be added corresponding amounts of corrosive pollutants, such as sulfur ions, chloride ions, etc., based on the content of corrosive pollutants in the natural environment where the outdoor unit 7 is tested.

Preferably, the service environment monitoring module and its monitored service environment parameters include:
multiple temperature sensors, which are used to monitor the internal temperature, the external air temperature, and the surface temperature of the outdoor unit 7 respectively, wherein the external air temperature is the air temperature of the tested natural environment in which the outdoor unit 7 is located,
multiple humidity sensors, which are used to monitor the internal and external humidity of the outdoor unit 7 respectively, wherein the external humidity is the humidity of the tested natural environment in which the outdoor unit 7 is located,
multiple airflow velocity sensors, which are used to monitor the internal and external airflow velocities of the outdoor unit 7 respectively, wherein the external airflow velocity is the airflow velocity of the tested natural environment in which the outdoor unit 7 is located,
multiple laser-based salt mist sensors, which are used to monitor the internal and external salt mist concentration of the outdoor unit 7 respectively, wherein the external salt mist concentration is the salt mist concentration in the tested natural environment in which the outdoor unit 7 is located,
multiple corrosion sensors, which are used to monitor the internal and external metal corrosion rates of the outdoor unit 7 respectively, wherein the external metal corrosion rate is the metal corrosion rate of the tested natural environment in which the outdoor unit 7 is located.

### Embodiment 2

On the basis of the Embodiment 1 mentioned above, Embodiment 2 adopts the following preferred implementation methods.

The preset method in step S4-3 includes:
step S4-3A: during the daytime of the accelerated corrosion test, when the rotating frame 3 stays in one position within the rotation angle range each time, the fluid atomization spray module 6 is controlled to spray atomized pure water to the location of the outdoor unit 7 within the preset humidification duration, in order to perform humidification treatment and increase the relative humidity and dry-wet alternation frequency around the outdoor unit 7;
during the dark time of the accelerated corrosion test, when the rotating frame 3 stays at one position within the rotation angle range each time, the fluid atomization spray module 6 is controlled to spray atomized salt solution to location of the outdoor unit 7 within the preset spray duration, and the sample surface temperature rise module 5 is controlled to heat the location of the outdoor unit 7 within the preset heating duration, in order to improve the salt mist concentration and temperature around the outdoor unit 7.

Wherein, the position change cycle is preferably 1 h, the humidification duration is preferably 10 min, and the spray duration and the heating duration are preferably 5 min.

Therefore, by adopting the method described in step S4-3A, the natural environment accelerated corrosion test method for air conditioners can be applied to the tested natural environment with stable environmental conditions and clear changes in environmental conditions, so as to conduct accelerated corrosion tests on multiple tested air conditioners under the same conditions, making the test more reproducible.

### Embodiment 3

On the basis of the Embodiment 1 mentioned above, Embodiment 3 adopts the following preferred implementation methods.

The preset method in step S4-3 includes:
step S4-3B: when the air temperature of the tested natural environment is lower than the preset air temperature threshold, the sample surface temperature rise module 5 is controlled to heat the location of the outdoor unit 7 within the preset heating time to increase the temperature around the outdoor unit 7;
when the average relative humidity of the tested natural environment is lower than the preset humidity threshold, the fluid atomization spray module 6 is controlled to spray atomized pure water to the location of the outdoor unit 7 within the preset humidification time for humidification treatment, to increase the relative humidity and dry-wet alternation frequency around the outdoor unit 7;
when the salt mist concentration of the tested natural environment is lower than the preset salt mist concentration threshold, the fluid atomization spray module 6 is controlled to spray the atomized salt solution to the position of the outdoor unit 7 within the preset spray time, so as to improve the salt mist concentration around the outdoor unit 7.

Wherein, the air temperature threshold is preferably 20° C.; the humidity threshold is preferably 80%; the salt mist concentration threshold is preferably 0.1 mg/m³; the humidification time is preferably 10 min, and the heating time and the spray time are preferably 5 min.

Therefore, by adopting the method described in step S4-3B, the natural environment accelerated corrosion test method for air conditioners can be applied to the tested natural environment with complex environmental conditions and unclear changes in environmental conditions, in order to conduct accelerated corrosion test on the tested air conditioner in a more resource efficient manner.

The disclosure is not limited to the specific embodiments described above. Based on the above content, according to the common technical knowledge and customary means in this field, and without departing from the basic technical idea of the disclosure, the disclosure can also be modified, replaced or changed in various other forms, all of which fall within the scope of protection of the disclosure.

What is claimed is:

1. A natural environment accelerated corrosion test device for air conditioners,
comprising a base, a rotating power unit, a rotating frame, an air flow acceleration module, a sample surface temperature rise module, a fluid atomization spray module, a service environment monitoring module, and a control system;
a top surface of the base is used to place and fix an outdoor unit of a tested air conditioner;
the rotating power unit is capable of driving the rotating frame to rotate back and forth around a central axis of the top surface of the base within a rotation angle range of 0° to 180°, a back of the outdoor unit fixed on the base faces in a direction that is not covered by the rotation angle range, and a left side of the outdoor unit, a front of the outdoor unit, and a right side of the outdoor unit are located at 0°, 90°, and 180° positions of the rotation angle range respectively, the front of the outdoor unit and a back of the outdoor unit are respectively the sides where a cooling fan of the outdoor unit and a condenser pipe of the outdoor unit are located;
The air flow acceleration module, the sample surface temperature rise module, and the fluid atomization spray module are installed on the rotating frame and face above the base; the air flow acceleration module can blow air towards a location of the outdoor unit; the sample surface temperature rise module can heat the location of the outdoor unit; the fluid atomization spray module can spray atomized pure water and salt solution separately to the location of the outdoor unit;
the service environment monitoring module is capable of real-time monitoring of service environment parameters of a tested natural environment in which the outdoor unit is located, and the service environment parameters are used to calculate accelerated corrosion test results of the tested air conditioner operating in the tested natural environment;
the control system is electrically connected to a control end of the rotating power unit, a control end of the air flow acceleration module, a control end of the sample surface temperature rise module, a control end of the fluid atomization spray module, and an output end of the service environment monitoring module.

2. The natural environment accelerated corrosion test device for air conditioners according to claim 1, wherein the rotating power unit is installed inside the base, a side of the base is provided with a connecting slot, and the top surface of the base is provided with several cable through holes;
the rotating frame is an L-shaped structure composed of a horizontal connecting rod and a vertical frame, the horizontal connecting rod extends into an interior of the base through the connecting slot, connected to a rotating shaft of the rotating power unit, the vertical frame is located outside the base, and the air flow acceleration module, the sample surface temperature rise module, and the fluid atomization spray module are all installed on the vertical frame;
a sensor host of the service environment monitoring module is placed inside the base, and sensor probes of the service environment monitoring module are arranged above the base, cables between the sensor host and the sensor probes passe through the cable through holes.

3. The natural environment accelerated corrosion test device for air conditioners according to claim 1, wherein the air flow acceleration module comprises a fan array composed of multiple fans, an air outlet of each of the multiple fans is equipped with a grille for adjusting a direction of air flow, and each of the multiple fans can be independently switched on and off and adjusted airflow velocity.

4. The natural environment accelerated corrosion test device for air conditioners according to claim 1, wherein the sample surface temperature rise module comprises multiple sets of infrared lamps distributed on both sides of the air flow acceleration module, which are installed in lamp slots with waterproof protection, the lamp slots can adjust a direction of an emitted light of the infrared lamps, and each set of the multiple sets of infrared lamps can be independently switched on and off.

5. The natural environment accelerated corrosion test device for air conditioners according to claim 1, wherein the fluid atomization spray module comprises a dual chamber water tank, an air compressor, and multiple ultrasonic nozzles, two chambers of the dual chamber water tank store pure water and salt solution respectively, the multiple ultrasonic nozzles are divided into two groups and arranged on a left side of the air flow acceleration module and a right side of the air flow acceleration module, the air compressor is capable of extracting pure water or salt solution from the dual chamber water tank and spraying pure water or salt solution through the multiple ultrasonic nozzles in an atomized manner after being pressurized by the air compressor.

6. The natural environment accelerated corrosion test device for air conditioners according to claim 1, wherein the service environment monitoring module and the service environment parameters monitored by the service environment monitoring module include:
multiple temperature sensors, which are used to monitor an internal temperature of the outdoor unit, an external air temperature of the outdoor unit, and a surface temperature of the outdoor unit respectively,
multiple humidity sensors, which are used to monitor an internal humidity of the outdoor unit and an external humidity of the outdoor unit respectively,
multiple airflow velocity sensors, which are used to monitor an internal airflow velocity of the outdoor unit and an external airflow velocity of the outdoor unit respectively, multiple laser-based salt mist sensors, which are used to monitor an internal salt mist concentration of the outdoor unit and an external salt mist concentration of the outdoor unit respectively,
multiple corrosion sensors, which are used to monitor an internal metal corrosion rate of the outdoor unit and an external metal corrosion rate of the outdoor unit respectively.

7. A natural environment accelerated corrosion test method for air conditioners,
wherein it is implemented based on the natural environment accelerated corrosion test device for air conditioners as claimed in claim 1, and includes:
step S1: install the tested air conditioner in its normal operating state, wherein an indoor unit of the tested air conditioner is installed indoors, and the outdoor unit of the tested air conditioner is in the tested natural environment and fixed on the top surface of the base;
step S2: power on the tested air conditioner, and set its operating time, operating mode, operating temperature, and operating air speed to common time period, cooling mode, minimum operating temperature, and maximum operating air speed, respectively;
step S3: power on the natural environment accelerated corrosion test device for air conditioners, and adjust a blowing position of the air flow acceleration module and a heating position of the sample surface temperature rise module according to a height of the outdoor unit, so that the outdoor unit as a whole is located within an effective air receiving area of the air flow acceleration module, and an outer surface of the outdoor unit can be uniformly heated;
step S4: control the natural environment accelerated corrosion test device for air conditioners through the control system to automatically operate in a following manner to achieve accelerated corrosion test of the tested air conditioner:
step S4-1: control the rotating power unit to drive the rotating frame to rotate back and forth within the rotation angle range, and control the rotating frame to stay at the 0° and 180° positions of the rotation angle range according to a preset position change cycle during an operation time of the tested air conditioner, and control the rotating power unit to drive the rotating frame to stay at the 0°, 90°, and 180° positions of the rotation angle range according to a position change cycle during a non-operation time of the tested air conditioner;
step S4-2: control the air flow acceleration module to operate continuously throughout the day;
step S4-3: according to a preset method, control the sample surface temperature rise module to intermittently heat the location of the outdoor unit; control the fluid atomization spray module to intermittently spray atomized pure water to the location of the outdoor unit for humidification; control the fluid atomization spray module to intermittently spray atomized salt solution to the location of the outdoor unit;
step S4-4: during a duration of the accelerated corrosion test, control the service environment monitoring module to monitor in real-time the service environment parameters of the tested natural environment in which the outdoor unit is located.

8. The natural environment accelerated corrosion test method for air conditioners according to claim 7, wherein a preset method in step S4-3 includes:
step S4-3A: during the daytime of the accelerated corrosion test, when the rotating frame stays in one position within the rotation angle range each time, the fluid atomization spray module is controlled to spray atomized pure water to the location of the outdoor unit within a preset humidification duration;
during a dark time of the accelerated corrosion test, when the rotating frame stays at one position within the rotation angle range each time, the fluid atomization spray module is controlled to spray atomized salt solution to the location of the outdoor unit within a preset spray duration, and the sample surface temperature rise module is controlled to heat the location of the outdoor unit within a preset heating duration.

9. The natural environment accelerated corrosion test method for air conditioners according to claim 7, wherein a preset method in step S4-3 includes:
step S4-3B: when the air temperature of the tested natural environment is lower than a preset air temperature threshold, the sample surface temperature rise module is controlled to heat the location of the outdoor unit within a preset heating time;
when an average relative humidity of the tested natural environment is lower than a preset humidity threshold, the fluid atomization spray module is controlled to spray atomized pure water to the location of the outdoor unit within a preset humidification time;
when a salt mist concentration of the tested natural environment is lower than a preset salt mist concentration threshold, the fluid atomization spray module is controlled to spray atomized salt solution to the position of the outdoor unit within a preset spray time.
